(19) United States
(12) Patent Application Publication
(10) Pub. No.: US 2026/0022722 A1
(43) Pub. Date: Jan. 22, 2026

(54) INSULATION FASTENER

(71) Applicant: USPLUSSEVEN HOMESTEAD INC., Newbridge (CA)

(72) Inventor: Jeremy MEAN, Newbridge (CA)

(73) Assignee: USPLUSSEVEN HOMESTEAD INC., Newbridge, NB (CA)

(21) Appl. No.: 19/271,178

(22) Filed: Jul. 16, 2025

Related U.S. Application Data
(60) Provisional application No. 63/671,819, filed on Jul. 16, 2024.

(51) Int. Cl. F16B 5/02; F16B 35/04; F16B 35/06

(52) U.S. Cl. CPC F16B 5/02; F16B 35/044; F16B 35/06

(57) ABSTRACT

The present invention provides a fastener for securing insulation to a surface comprising a first end for securing the fastener to a surface and a second end with a flat surface for contact with the insulation. The fastener has an elongated body interconnecting the first end and second end with the elongated body traveling the length of the insulation secured to the surface.

### CROSS-REFERENCE TO RELATED APPLICATION

The present application claims priority to U.S. Provisional Application No. 63/671,819, entitled “Insulation Securement Extension Sleeve with a Milling Tip, a Captive Screw and a Thermal-Break Cap” filed on Jul. 16, 2024, the contents of which are incorporated herein by reference in their entirety.

### FIELD OF THE INVENTION

The present invention pertains to the fasteners and more particularly, to fasteners for securing insulation and insulation panels to a surface.

### BACKGROUND OF THE INVENTION

Insulation panels installed on the roof or on exterior walls of a building are generally made of expanded foam, for example, having relatively low tensile strength. These panels are preferably and conveniently attached to a supporting structure of wood or concrete with screws with large disc-type washers. When the panels are relatively thick, the length of screws required is unfeasible to meet the torsion requirements. Therefore, it is common to use extension sleeves having length equivalent to the thickness of the panel to position the screws as close to the substrate as possible. Such extension sleeves are described in the following prior art documents: U.S. Pat. Nos. 4,881,861, 4,932,819, 5,054,983, 5,094,057, 5,122,022, 5,171,118, 5,265,998, 5,660,015, 5,907,938, 6,709,214, 9,551,157, 9,951,803, 10,228,007, 11,698,095, CZ Patent 292,858 and CA Patent 2,805,585.

As can be appreciated, the installation of these extension sleeves through insulation panels requires some training and know-how. Foam insulation has a low tensile strength, and therefore, it cannot be installed by workers acting hastily and recklessly. Referring to FIG. 1 of the drawings, when the extension sleeve 20 is pushed forcefully and quickly through the panel 22, it can cause a flake 24 to be blown off the backside of the panel as illustrated. The flake 24 often hangs on to the screw and rotates with the screw, as shown in FIGS. 1-3, or fall off between the panel 22 and the substructure 28 as illustrated in FIG. 4.

A flake 24 blown off the backside of the panel is never a perfect circle, and therefore, does not nest perfectly in cavity 30 where it came from when the panel is brought closer to the substructure 28. As a result, the panel 22 is installed with air gaps 32 between the panel and the substructure, high spots 34 on the exterior surface of the panel and a reduced attachment length 36 of the screw to the substructure.

### SUMMARY OF THE INVENTION

The present invention provides an insulation fastener for securing insulation to a surface comprising a first end for securing the fastener to a surface and a second end with a flat surface for contact with the insulation. The fastener has an elongated body interconnecting the first end and second end with the elongated body traveling the length of the insulation secured to the surface.

In the present invention, there is provided a fastener having threads on its tip for milling a hole through an insulation panel, for example, and for reducing the chances of blowing a flake away from the panel. The thread on the tip has the same diameter as the outside surface of the elongated body of the present invention. Therefore, when the fastener is pushed through an insulation panel for example, it does not apply pressure on the insulation than what a plain elongated body without thread of the same diameter would apply.

In the present invention, a metal faster can be incorporated in the tip of the fastener. The head screw is molded into the tip of the sleeve. A hexagon socket can also be formed inside the second end of the fastener for connecting with a hexagon bit of a hand-held tool. The fastener of the present invention is made to be installed with a hand-held rotating tool such that the threads can mil a hole through an insulation panel while compressing the insulation particles inside the hole to ensure an airtight fit of the fastener in the hole.

### BRIEF DESCRIPTION OF THE FIGURES

The embodiments of the present invention will now be described by reference to the following figures, in which identical reference numerals in different figures indicate identical elements and in which:

FIG. 1 is a side view of existing prior art showing an extension sleeve is positioned through a panel;

FIG. 2 is a top view of a flake which is produced according to the existing prior art;

FIG. 3 is a side view of existing prior showing a flake being torn off and rotating with a screw;

FIG. 4 is another side view of existing prior art showing a flake falling below the surface of a panel;

FIG. 5 is a perspective view of a fastener according to one embodiment of the present invention;

FIG. 6 is a side view of a fastener according to one embodiment of the present invention;

FIG. 7 is a top perspective view of a fastener according to one embodiment of the present invention;

FIG. 8 is a side view of a partial fastener to be positioned through insulation positioned on a surface according to one embodiment of the present invention;

FIG. 9 is a side view of a partial fastener piercing insulation positioned on a surface according to one embodiment of the present invention;

FIG. 10 is a side view of a partial fastener traveling through insulation positioned on a surface according to one embodiment of the present invention;

FIG. 11 is a side view of a fastener having traveled through insulation and secured to a surface according to one embodiment of the present invention;

FIG. 12 is a cut-away view of a fastener showing a hollow body according to one embodiment of the present invention; and

FIG. 13 is a top perspective view of a fastener having a cap molded on the top surface of a fastener according to one embodiment of the present invention.

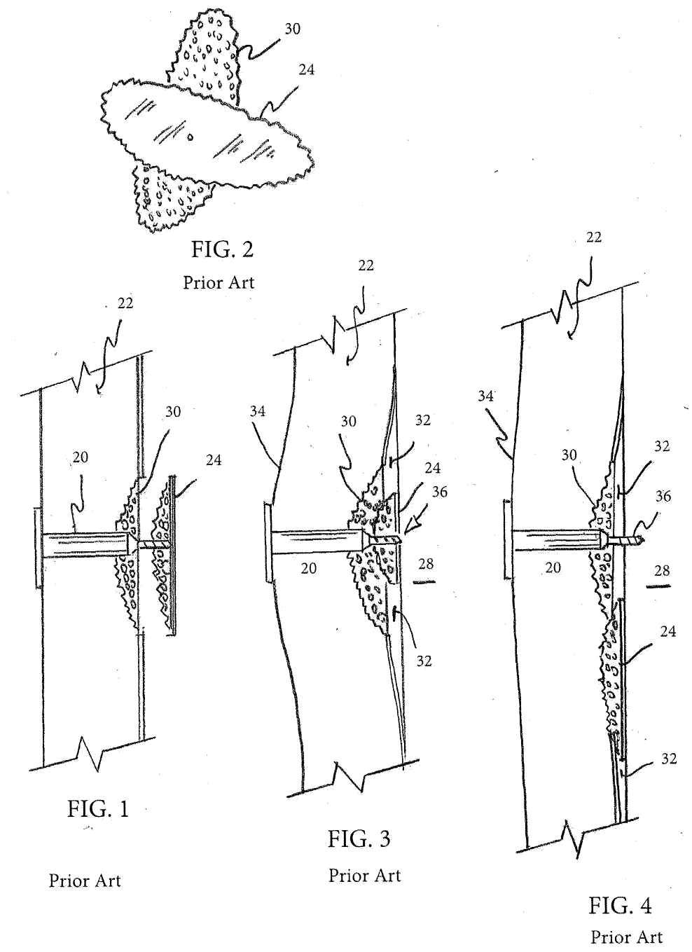

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

The present invention includes an insulation fastener for securing insulation to a surface comprising a first end for securing the fastener to a surface, a second end with a flat surface for contact with the insulation and an elongated body interconnecting the first end and second end, the elongated body traveling the length of the insulation secured to the surface.

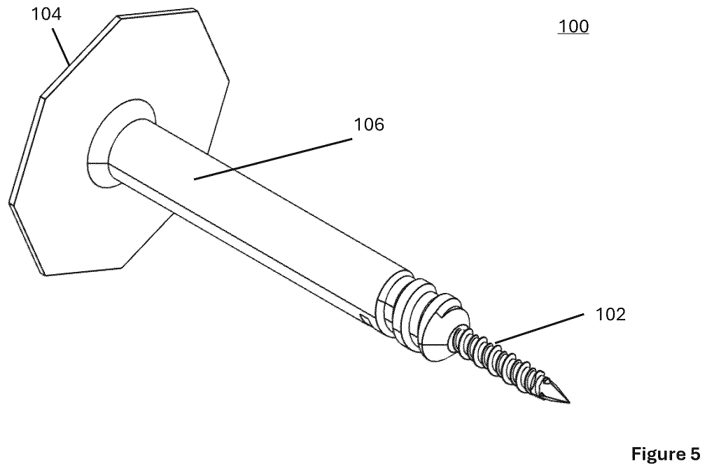

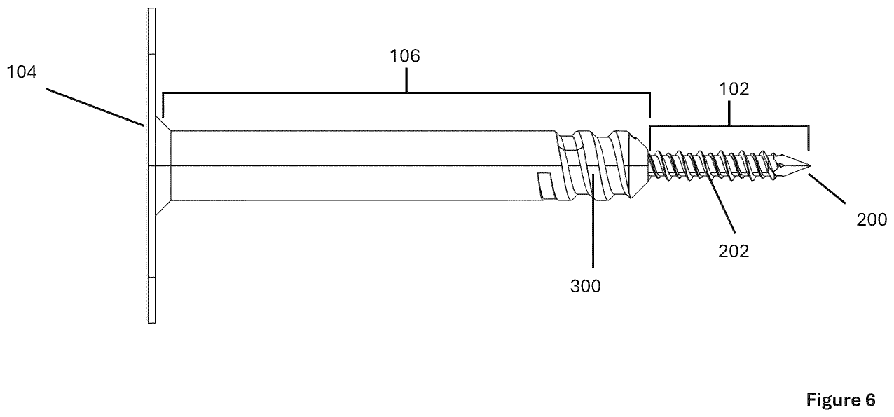

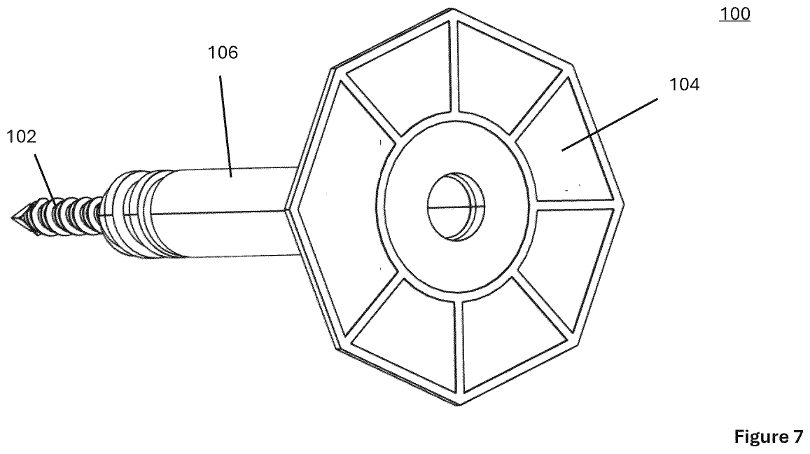

With reference to FIGS. 5-7 and according to one embodiment of the present invention, a fastener 100 is shown. Fastener 100 has a first end 102 and a second end 104. Fastener 100 also has an elongated body 106 which interconnects first end 102 and 104. Elongated body 106 can be of varied length in order to provide various applications when securing an insolation panel on a surface. Elongated body 106 depending on the application will travel the length of the insulation panel secured to a surface by first end 102. Insulation under the present invention can contain insulation panels as well as any other type of insulation which has an outer surface securing insulation against a surface. In other words, the present fastener could secure fiberglass insulation which is covered with a plastic film commonly found in residential homes.

With further reference to FIGS. 5-7 and according to one embodiment of the present invention, fastener 100 has a first end 102 which has a piercing tip 200 and a threaded surface 202. Elongated body 106 has a threaded section 300. Threaded section 300 is preferably positioned proximate to first end 102.

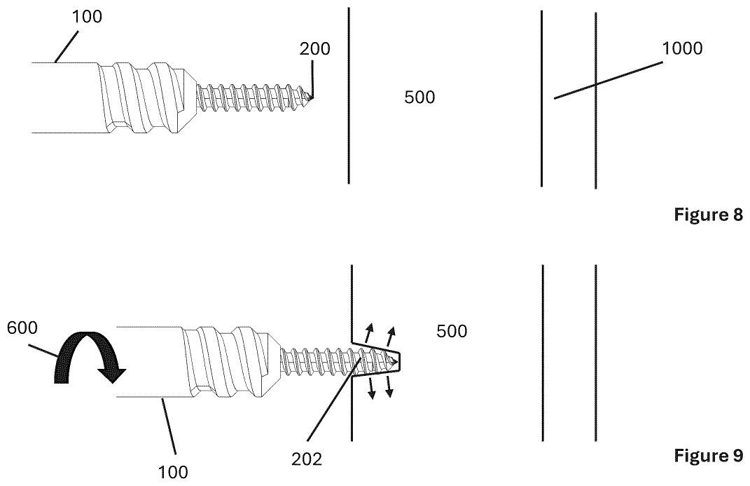

With reference to FIGS. 8 and 9 and according to one embodiment of the present invention, the presence of piercing tip 200 allows for fastener 100 to initially pierce an insulation surface 500 without causing a large entry point which can cause a flake as described above. Once tip 200 has pierce the insulation surface, threaded surface 202 displaces insulation away from threaded section 202 (as shown with the arrows) thus condensing the insulation surrounding the threaded surface 202. This condensing action reduces the possibility of a flake being created when introducing the fastener in insulation 500 when securing the insulation to a surface 1000.

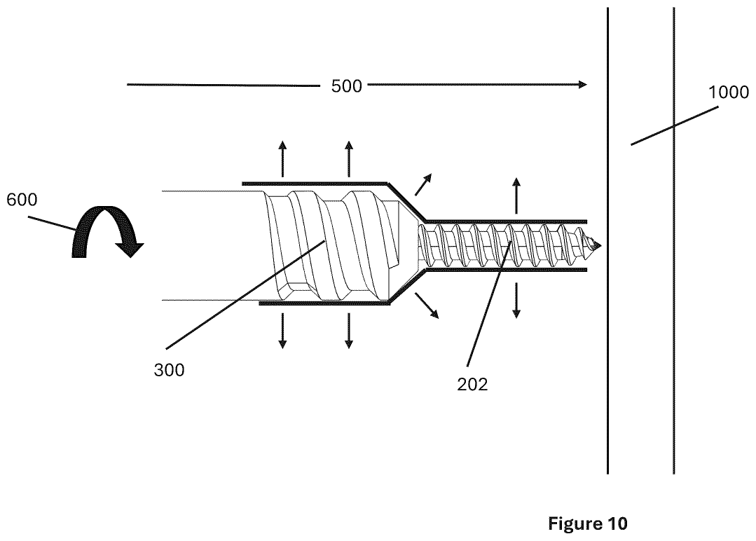

With reference to FIG. 10 and according to one embodiment of the present invention, threaded section 300 will enter opening made by piercing tip 200 (as shown in FIG. 9) when securing the fastener to a surface 1000. Specifically, the condensing action first created by the threaded surface 202 of first end 102 is continued through threaded section 300 since threaded section 300 will enlarge the entry point in the insulation. The enlargement of the entry point will further condense the insulation around fastener 100 further reducing the chance of a flake being created. The presence of threaded portion 300 threaded surface 202 allows for rotational movement 600 of a fastener when traveling through insulation 500 to be secured to a surface 1000. The rotational movement 600 reduces the chance of flakes developing as described above.

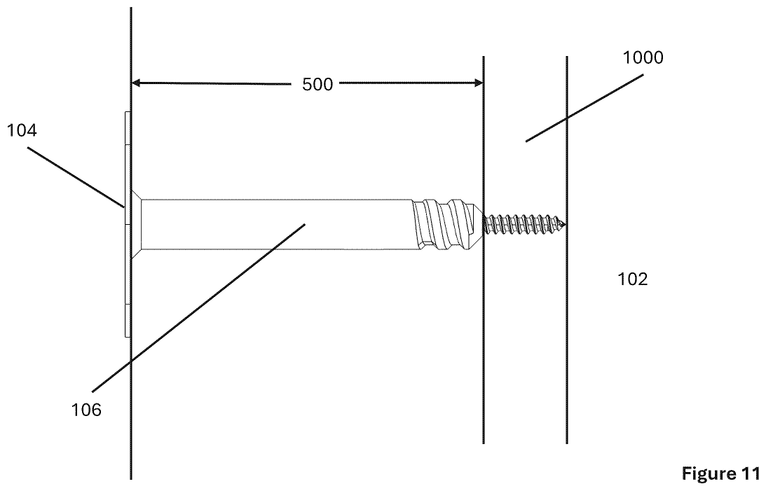

With reference to FIG. 11 and according to one embodiment of the present invention, fastener 100 is secured to a surface 1000 wherein the elongated body 106 has traveled the length of insulation 500. First end as also traveled into surface 1000 allowing to properly secure fastener 100 to said surface 1000. Surface 1000 can be either wood, steel, concrete or drywall. Depending on the nature of the surface to secure any insulation, the fastener of the present invention can be modified to have a first end 102 which will be constructed to pierce either wood, steel, concrete or drywall. Threaded section 300 does not enter or pierce surface 1000. In alternative embodiments of the present invention, threaded section may be configured to allow a portion of elongated body 106 to be secure to surface 1000. Threaded section 300 could include a funnel shape having threads for example. Under such an embodiment, the fastener would require additional rigidity to pierce into wood, steel, concrete and drywall. The present fastener can be manufactured using plastic or any other material which allows to mold a fastener of the present invention. A worker skilled in the relevant art would be familiar with the types of materials which can be used to manufacture the present fastener as described herein.

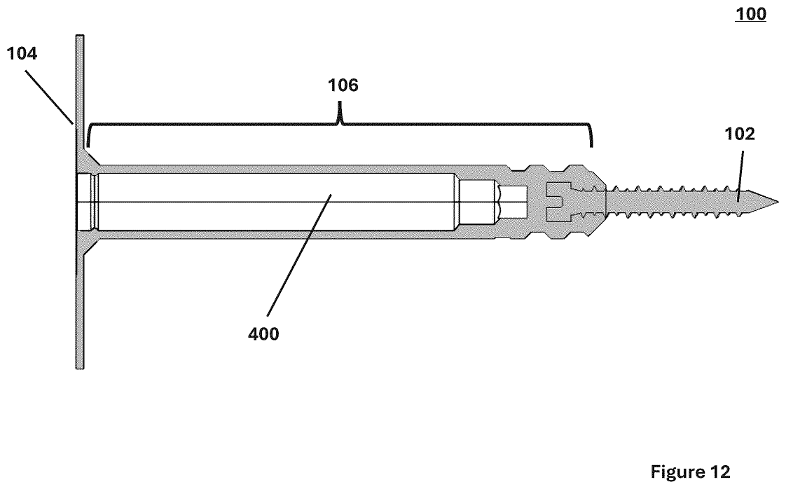

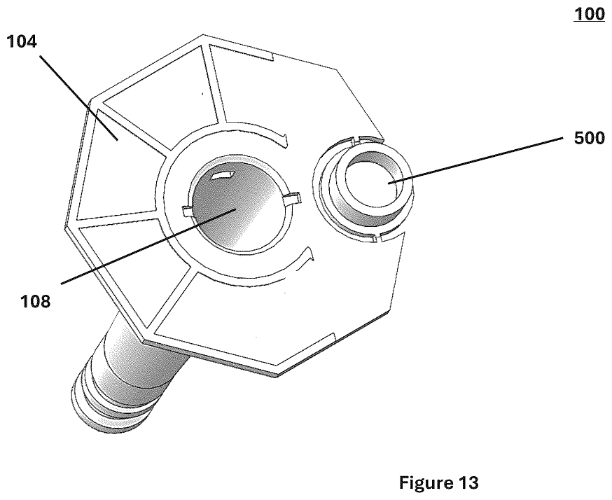

With reference to FIG. 12 and according to one embodiment of the present invention, fastener 100 has a hollow interior 400 within elongated body 106. The presence of hollow body 400 allows for the placement of a drill bit within hollow body 400 allowing to rotate fastener 100 when securing to a surface as described above. With further reference to FIG. 12 and according to one embodiment of the present invention, first end 102 is molded to elongated body 106 providing a single piece fastener. In an alternative embodiment, first end 102 could be either snap fitted, wedged or even glued to elongated body 106 providing a two-piece fastener adaptable to the surface onto which the fastener will be secured to for example.

With reference to FIG. 13 and according to another embodiment of the present invention, a fastener 100 is shown having a detachable cap 500. Cap 500 is molded into the top surface of second end 104 which allows cap 500 to be detachable from said top surface. Once removed, cap 500 can be positioned into opening 108 which leads to the hollow interior as shown in FIG. 12. The placement of cap 500 onto opening 108 allows to contain any cold or warm air which might be transferred to the fastener from the insulation.

In another embodiment of the present invention, cap 500 may be provided separately from the fastener rather than being molded onto top surface 104 as shown in FIG. 13.

The present fastener could also have a solid interior without the hollow interior as shown in FIG. 12. Under such an embodiment, opening 108 would need to be deep enough to secure a drill bit as would be known by a worker skilled in the relevant art.

In the present invention, there is provided a fastener having threads on its tip for milling a hole through an insulation panel, for example, and for reducing the chances of blowing a flake away from the panel. The thread on the tip has the same diameter as the outside surface of the elongated body of the present invention. Therefore, when the fastener is pushed through an insulation panel for example, it does not apply pressure on the insulation than what a plain elongated body without thread of the same diameter would apply.

In the present invention, a metal faster can be incorporated in the tip of the fastener. The head screw is molded into the tip of the sleeve. A hexagon socket can also be formed inside the second end of the fastener for connecting with a hexagon bit of a hand-held tool. The fastener of the present invention is made to be installed with a hand-held rotating tool such that the threads can mil a hole through an insulation panel while compressing the insulation particles inside the hole to ensure an airtight fit of the fastener in the hole.

The present invention provides an insulation fastener for securing insulation to a surface comprising a first end for securing the fastener to a surface and a second end with a flat surface for contact with the insulation. The fastener has an elongated body interconnecting the first end and second end with the elongated body traveling the length of the insulation secured to the surface.

The present invention also provides a fastener wherein the first end has an extended portion having a smaller diameter than the elongated body.

The present invention also provides a fastener wherein the extended first end has a threaded section.

The present invention also provides a fastener further comprising a threaded portion on the elongated body.

The present invention also provides a fastener according wherein the threaded portion on the elongated body is proximate to the first end.

The present invention also provides a fastener wherein the elongated body as a hollow opening allowing for placement of a tool head within the hollow opening.

The present invention also provides a fastener wherein the second end has an enlarged surface for contact with the insulation.

The present invention also provides a fastener wherein the entire fastener is molded as a single piece.

The present invention also provides a fastener further comprising a cap for covering the hollow opening.

The present invention also provides a fastener further comprising a detachable cap positioned on the flat surface of the second end.

A person understanding this invention may now conceive of alternative structures and embodiments or variations of the above all of which are intended to fall within the scope of the invention as defined in the claims that follow.

1. An insulation fastener for securing insulation to a surface comprising:
a first end for securing the insulation fastener to a surface;
a second end with a flat surface for contact with the insulation;
an elongated body interconnecting the first end and second end, the elongated body traveling the length of the insulation secured to the surface.

2. The insulation fastener according to claim 1 wherein the first end has an extended portion having a smaller diameter than the elongated body.

3. The insulation fastener according to claim 2, wherein the extended first end has a threaded section.

4. The insulation fastener according to claim 1, further comprising a threaded portion on the elongated body.

5. The insulation fastener according to claim 4, wherein the threaded portion on the elongated body is proximate to the first end.

6. The insulation fastener according to claim 1 wherein the elongated body as a hollow opening allowing for placement of a tool head within the hollow opening.

7. The insulation fastener according to claim 1 wherein the second end has an enlarged surface for contact with the insulation.

8. The insulation fastener according to claim 1 wherein the entire fastener is molded as a single piece.

9. The insulation fastener according to claim 1 further comprising a cap for covering an opening on the second end.

10. The insulation fastener according to claim 1 further comprising a detachable cap positioned on the flat surface of the second end.
